(19) United States
(12) Patent Application Publication
(10) Pub. No.: US 2016/0305156 A1
(43) Pub. Date: Oct. 20, 2016

(54) ADJUSTABLE DOOR STRIKE PLATE AND METHOD OF USING THE SAME

(71) Applicants: Dennis Kamody, Pittsburgh, PA (US); Candice Kamody Welsh, Pittsburgh, PA (US)

(72) Inventors: Dennis Kamody, Pittsburgh, PA (US); Candice Kamody Welsh, Pittsburgh, PA (US)

(21) Appl. No.: 14/690,457

(22) Filed: Apr. 19, 2015

(51) Int. Cl. E05B 15/02

(52) U.S. Cl. CPC E05B 15/024

(57) ABSTRACT

A door strike plate that can be temporarily mounted to a first location for proper alignment, tested while still temporarily mounted and moved to a second or more locations until satisfactorily aligned. It comprises a metal strike plate having a plurality of mounting screw holes on a top and bottom side of a latch or deadbolt hole; an appropriately sized dot of an adhesive/putty applied to a region adjacent each mounting screw hole. A method for installing this door strike plate is also disclosed.

### BACKGROUND OF THE INVENTION

When installing door lock sets, the location where the strike plate or dead bolt plate gets positioned to a wooden door jam can be critical. Both amateurs and professional door installers have a propensity to miss the correct strike plate location when securing with screws to complete the installation. The less skilled the installer, the higher the propensity to “miss”. Even a highly skilled installer may not find the best strike plate installation fit on his/her first attempt.

The propensity to miss finding a satisfactory, if not ideal, strike plate location before fastening the same with screws is challenging when installing a lock set on a new construction or when replacing one existing lock set with another. This is due to the designed shape and required functional location of a strike plate with respect to the mating door lock set moving actuator. There is little space or clearance between the door assembly edge and this plate. It is difficult to measure and then mark the exact location of the plate for the mating-alignment with the latch or dead bolt with any reasonable accuracy. Only after the screws are installed to fasten the striker plate to the frame may the installer realize that he/she has not set the plate in the right location. Sometimes, a second or third attempt is needed to mount/remount the plate to the right location for proper functioning.

When a new plate mounting is attempted, the previous screw holes created in the surrounding wooden jam can become an issue. That's because of the risk that during strike plate relocation a second (or third) time, the screws may lead-off or be drawn back into prior screw holes. Sometime, installers attempt to insert a wooden dial or some wood putty into erroneous holes before attempting to install the screws in their next location. The effect/end result of a misplaced striker plate is often frustrating and irksome. An erroneously mounted strike plate may be too far in, out, up or down. That results in a door that does not close/open easily, or smoothly. When the door is shut, it will rattle or have sufficient vertical or horizontal movement as to raise issues of security, sound dampening and/or energy efficiency. Often times, patience is required to install a strike plate to fit properly. Most strike plates have little or no “adjust” features. The typical T-type latch, strike plate design used on a large majority of door lock sets features an inside tab with a screw driver slot that can be adjusted inwardly by bending that tab ever so slightly. But such latch/tabs provide only a narrow range of adjustment . . . and usually just in one direction. This semi-adjustable feature is typically overlooked by the average installer who may not even know the purpose of that tab.

The known prior art of adjustable strike plates is limited in use for many reasons. Typically, adjustability is achieved from metal mechanical design features using stab-in tabs, pins, nuts and bolts, movable wing plates and/or boxed-in cavities, all of which have a limited range for adjustment. And, all such prior art variations require some level of mechanical skill and/or many trial and error correction steps to properly adjust a given door strike plate. Self-adjusting strikers, such as those employing a pin-type feature are also relatively costlier yet still serve a limited product range. The stab-in type tab has a dart board effect with more trial and error tries to duly align leading to more damage/marring to the doorjamb. Still other prior devices that use a jig tool fixture for locating the preferred strike plate mounting location lack accuracy if the installer lacks mechanical skills.

Prior known systems that used adhesives with strike plates actually used them as a substitute for permanent mounting screws, attaching guard protectors or for attaching a temporary template to identify potential marking locations. Since many strike plates may be replaced or changed-out over a replacement door lock-set, there is great risk of defiling doorjamb wood surfaces when removing a strike plate attached with adhesive. As such, adhesives are not commonly used to replace strike plate permanent mounting screws.

In the carpenter trade, adhesives are generally used to permanently attach/join one object to another. But there is no common practice, or even obvious suggestion to use an adhesive for adjustably mounting a new or replacement strike plate.

Generally, putties are used to fill in voids, seal or function as a barrier by carpenters. Before strike plate mounting, wood putty has been used to fill in old screws holes, cracks or splits in a wooden doorjamb. After mounting the plate, putties or caulking may be used to seal in open borders/boundaries between the mounted strike plate and the adjacent doorjamb. As such, it would not be obvious to a skilled (or unskilled) carpenter to use removable type adhesive/putty for proper strike plate locating/positioning. The properties of such adhesives as a fastener or filler are poor. Most putties are not removable nor especially “movable”. Some only become effective after setting or cure time has passed.

Representative patents in this field include the strike plate template of Lucia U.S. Pat. No. 2,862,302, the method for forming and installing a strike plate from Schlage et al. U.S. Pat. No. 3,057,053, the self attaching door strike plate of Jones U.S. Pat. No. 5,094,489 and the door reinforcing plate of Griffin Can. Patent No. 2,088,726.

### SUMMARY OF THE INVENTION

The present invention is a device and a related method of use that constitutes an improvement over the art and any previous strike plate patents. It overcomes the frustrations of mismarking and decreases the time needed to properly install a strike plate in its correct location prior to using mounting screws to permanently mount the striker in place. It accomplishes the same without any conventional measuring, marking requirements or repeated trial-and-error mounting damage to the doorjamb. The device of this invention makes it easy for both the skilled and less (or un) skilled installer to achieve the same results. The device is cost effective. It requires a fraction of the time to properly install a new or replacement strike plate, especially when compared to its known alternatives. The device is easy to install and test for assuring proper location. It uses a new method to install a strike plate before closing/opening the door and making one or more corrective adjustments thereto (if any) until the door opening and closing action results in a perfect or nearly perfect (i.e. “satisfactory”) fit. Only then should the duly positioned strike plate be permanently secured using fastening screws. The resulting installation WITH this invention makes the door easier to close and open, significantly less rattle prone, more sound dampening, and energy efficient.

The device of this invention includes an adhesive/putty with special properties. It would not be obvious to use this adhesive/putty in the preferred, proper volume distributions called for herein below. If under puttied, or over puttied, moving the strike plate to a new location could result in the moved plate slipping back to its previous (undesired) position. Wrong putty volumes can also lead to premature or overextended strike plate adhesive, the latter making it more difficult to remove AND move to the next location over time. Excess adhesive may, in turn, lead to strike plate interference with the doorjamb proper and/or bending/bowing of the strike plate itself.

The device allows a new method of installing/locating THE correct strike plate connectivity position for a given door latch or dead bolt without the risk of a misstep, i.e., installing with permanent fastening screws in a wrong location.

### BRIEF SUMMARY OF THE DRAWINGS

Further features, objectives and advantages will become clearer with the detailed description made with reference to the accompanying drawings in which:

FIG. 1 is a perspective view showing installation of a door latch strike plate according to one embodiment of this invention;

FIG. 2 is a perspective view showing installation of a dead bolt strike plate with security reinforcer according to a second embodiment;

FIG. 3 is a plan view of the back side to a strike plate fitted with adhesive;

FIG. 4A is a front plan view of the front side to a flat backed, door latch strike plate per one embodiment;

FIG. 4B is a front plan view of the front side to a flat backed, two-screw flat plate per one embodiment;

FIG. 4C is a front plan view of the front side to a flat backed, four-screw flat plate per one embodiment:

FIG. 4D is a front plan view of the front side to a flat backed, six-screw flat plate per one embodiment:

FIG. 5A is a front plan view of the front side to a protruding, door latch strike plate per a second embodiment:

FIG. 5B is a front plan view of the front side to a protruding, two-screw flat plate per a second embodiment;

FIG. 5C is a front plan view of the front side to a protruding, four-screw flat plate per a second embodiment:

FIG. 5D is a front plan view of the front side to a protruding, six-screw flat plate per a second embodiment;

FIG. 6A is a side sectional view of a flat backed, strike plate per one embodiment;

FIG. 6B is a side sectional view of a protruding strike plate per an alternate embodiment;

FIG. 7A is a top plan view showing a first pattern of adhesive applied to the back side of a door latch strike plate per this invention:

FIG. 7B is a top plan view showing a first pattern of adhesive applied to the back side of a four-screw flat plate per this invention;

FIG. 8A is a top plan view showing a first pattern of adhesive applied to the back side of a two-screw flat plate per this invention;

FIG. 8B is a top plan view showing a second pattern of adhesive applied to the back side of a door latch strike plate;

FIG. 9 is a top plan view showing a first pattern of adhesive applied to the back side of a long six-screw flat plate (on the left) and shorter six-screw flat plate (right side) per this invention;

FIG. 10A is a front plan view showing the first method step for installing a door latch strike plate;

FIG. 10B is a schematic view showing the second method step of closing a door against a first positioned strike plate per one embodiment;

FIG. 10C is a schematic view showing the other part of that second method step, tugging on a closed door for further testing whether the temporarily located strike plate is satisfactorily situated (or aligned); and

FIG. 10D is a front plan view showing the third method step per this invention.

### DETAILED DESCRIPTION OF PREFERRED EMBODIMENTS

The device of this invention is comprised of three components: a latch or dead bolt metal strike plate, an adhesive/putty with special properties and applied at preferred quantities, and a plurality of permanent mounting screws. The adhesive/putty is applied to the back face of a strike plate for making the latter mount-adjustable. The device requires an installer's finger pressure to first apply to the surface of a doorjamb and then, after checking whether properly located, sliding to a second (third or more) mounting location if needed.

The volume amount of special properties adhesive/putty to be used on the back side of a strike plate has a preferred minimum and maximum. If applied at too little volume, or too low in quantity, the strike plate will not be able to be slid/shifted and then held in place at a new, secondary position. Or, it may separate/detach/not stick and fall away from the doorjamb before the final, permanent mounting screws are installed. If applied with too great a volume/quantity of adhesive-putty, the strike plate will not satisfactorily finger-press in place. It will not compress sufficiently resulting in a strike plate that interferes with (or binds) the door's inside edge surface on closing and/or opening. Furthermore, too much adhesive volume (especially in the wrong location(s)) can act as a wedge or undesirable spacer that could deform, bend or bow the metal strike plate when final mounting screws are set therein.

Should an excess volume of adhesive/putty compress, the strike plate to which it has been applied may cause adhesive/putty to bleed-out beyond the back side surface and flow into the strike plate's screw holes and/or into the door's latch or dead bolt opening causing interference with latch/dead bolt connectivity. Even worse, excess adhesive/putty may not allow the permanent mounting screws to recess flush with the front face surface of the strike plate. Rather, it may ooze out and through these holes thereby blocking proper mounting of the final, permanent screw attachments to the doorframe.

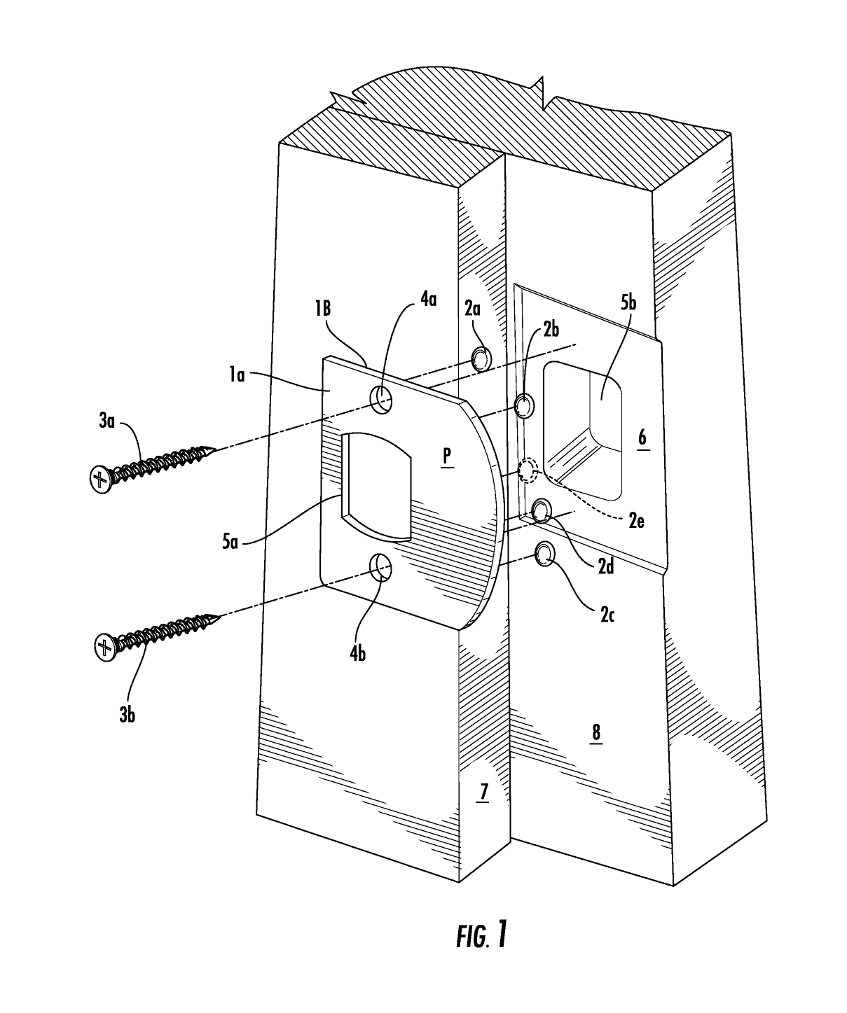

In FIG. 1, there is shown a perspective view of one door latch strike plate mounting according to the present invention. Particularly, it shows the mounting of a strike plate P with its front face 1a and back face 1b to the doorjamb 8 adjacent a typical door stop 7. Into the latter door jamb 8, there was previously cut or machined a latch mortise 5B surrounded by its plate mortise 6. On both sides of the latch hole 5b in strike plate P, to its back face 1b, there are positioned a plurality of adhesive/putty dollops/dots or spheres (2a through 2d). An optional fifth dot 2e, is shown by dashed lines to underscore its less preferred application. All of these dots are ideally positioned so as to not interfere with (including possibly “bleed” or ooze into and through) the mounting holes 4a-b of plate P when the proper position of plate P has been located and readied for the final mounting of plate P to the mortise 6 in jamb 8 with permanent screws 3a-b.

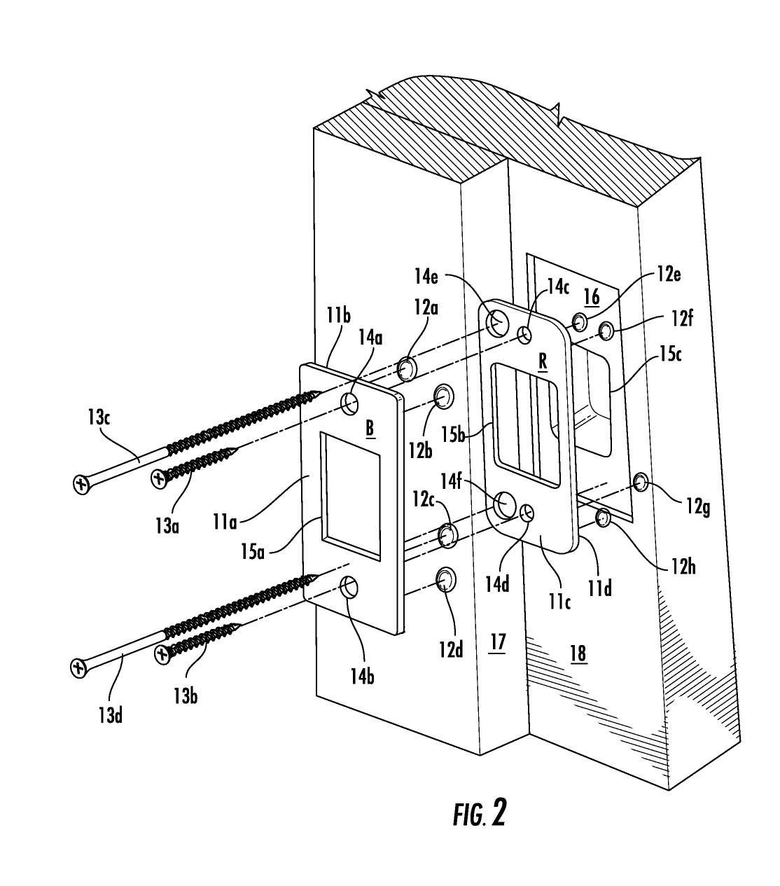

FIG. 2 shows an alternate variation for a flat-backed, dead bolt strike plate B using an intermediary security reinforcer R before mounting to its doorjamb 18 adjacent door stop 17. This is similar to the 2 holed installation at FIG. 1 except that adhesive/putty dots 12a-d for the strike plate B are supplemented with additional adhesive dots/dollops 12e-h for further securing the reinforcer R in place within dead bolt mortise 15c.

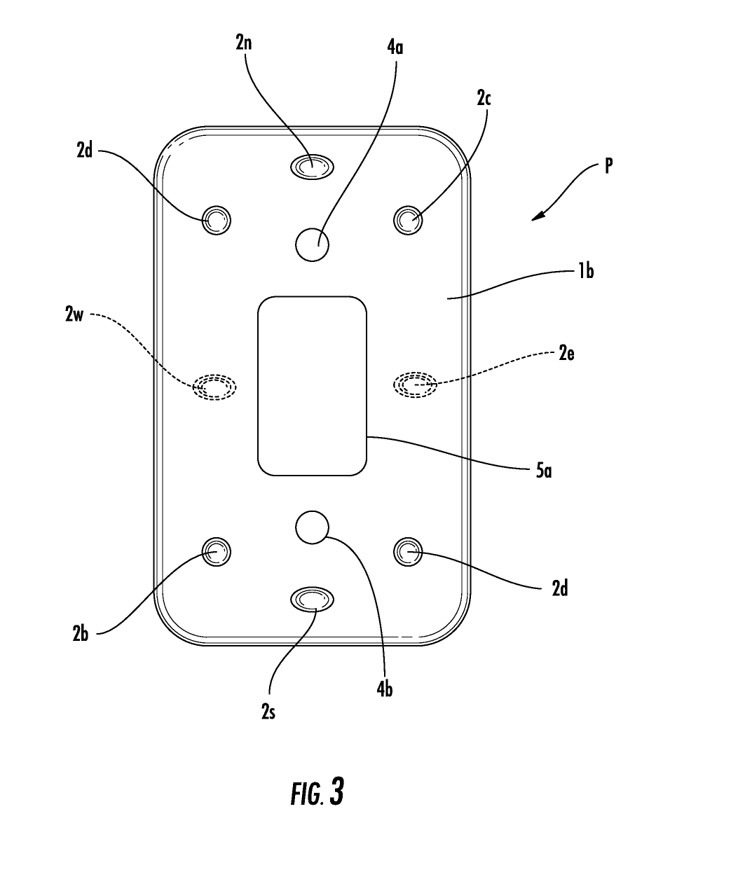

FIG. 3 shows a close up view for one preferred strike plate P, back side 1b with its screw holes 4a-b on either side of latch hole 5a. To this plate, there is positioned four dots/ovals of adhesive/putty 2a-d at the four corners to strike plate P. One less preferred alternative placement of these same adhesive dot/oval locations, at the four compass points (north-east-south and west) surrounding latch hole 5a, is indicated via markers 2n, 2e, 2s and 2w, with the optional (or less preferred) nature of east and west (2e, 2w) dots indicated through dashed (rather than solid) lines. Either the upper and lower pair or set of all four dots is intended to temporarily hold the plate P in place for proper positioning after which the plate would be permanently mounted to the surrounding door frame with screws (not shown). Note, however, that these adhesive/putty dots or ovals will not get removed. They are intended to stay in place and remain with the strike plate when permanently mounted to the frame/doorjamb proper.

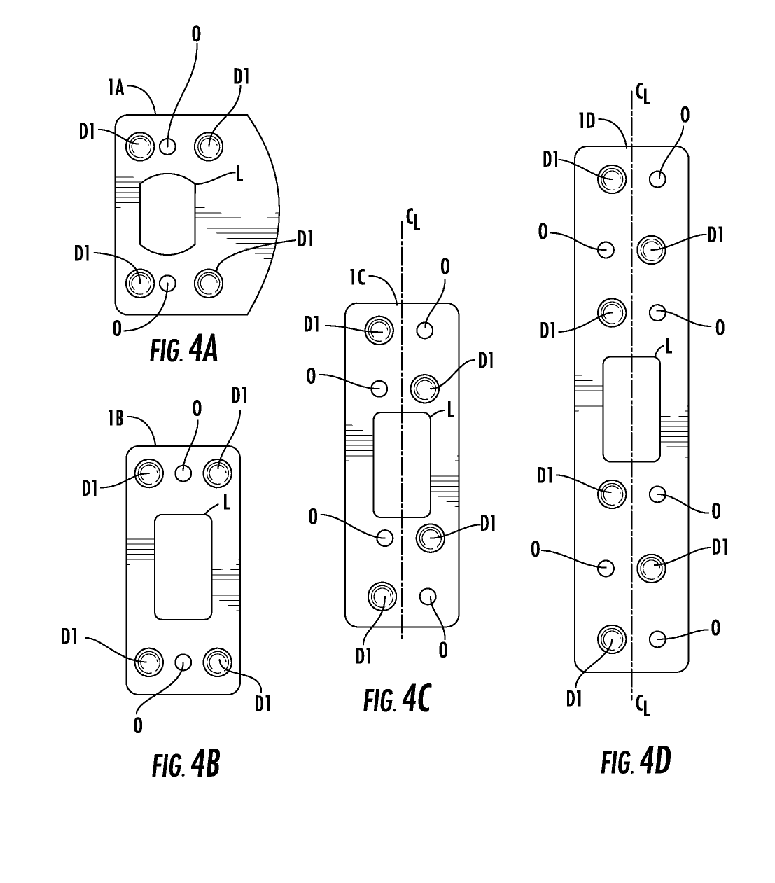

The preferred volumes of adhesive/putty to be applied and their preferred locations on the back surface of a strike plate has been determined through testing. These results are shown in FIGS. 4A through 6B. Factors in determining preferred deposit volumes include: the back side surface of the strike plate itself (i.e., flat versus protruding), the total number of screw holes in the plate proper and the horizontal centering of those screw holes. In FIGS. 4A through 4D, there are shown adhesive deposits for a typical lipped strike plate (4A) and a flat back strike plate (4B), each of which has a single screw hole O centered substantially horizontally. For those two “main” embodiments, adhesive/putty dots D1 are deposited at two locations, on the left and right of each screw hole O in preferred quantities of 0.05 grams or a ⅛″ diameter of deposited adhesive (or “dot”).

In the remaining views at FIG. 4, there are multiple screw holes O on either side of latch hole L, none of which are substantially horizontally centered. Rather, these screw holes O are intentionally staggered, on either side of an imaginary, vertically-extending center line CL. For the 4 hole version (4C) and six hole variety (4D), the preferred quantities of adhesive/putty D1 deposited is 0.10 grams or a 3/16″ diameter dot adjacent EACH screw hole O.

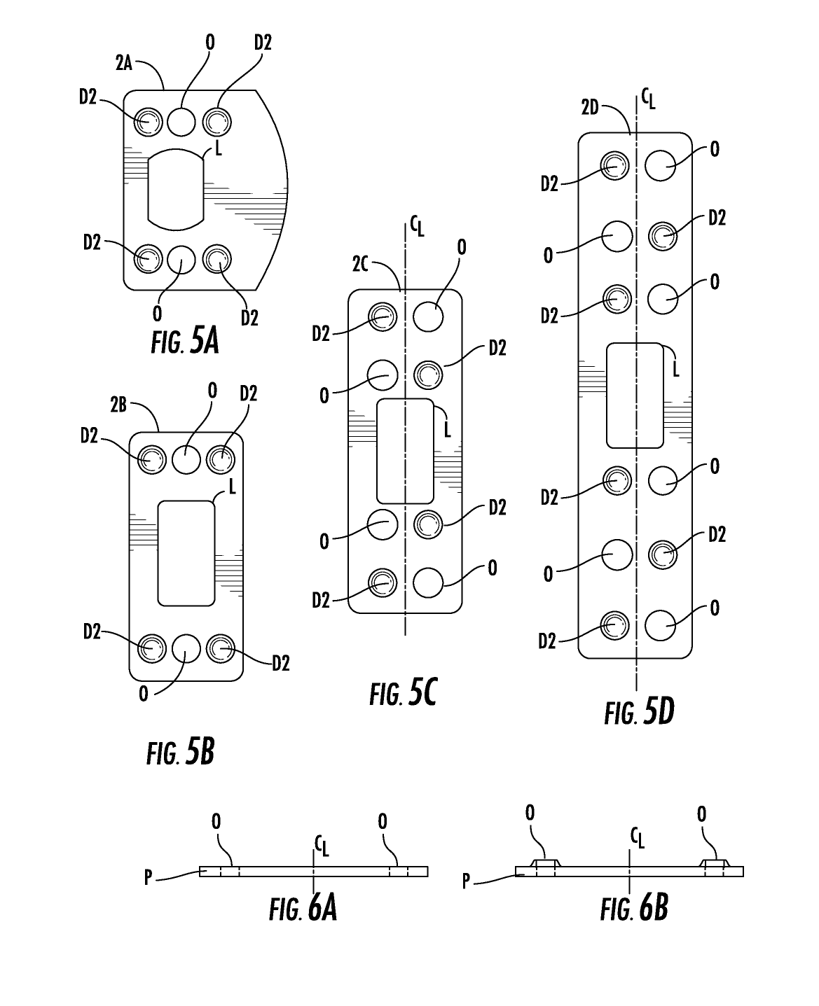

In FIGS. 5A through 5D, the strike plates P are not flat backed but rather partially protruding (the differences between strike plate versions being better seen in the cross-sectional views for each at FIGS. 6A (flat-backed) and 6B (protruding)). In all of the FIG. 5 strike plate variations with a protruding backside surface, there are greater quantities of adhesive/putty required PER screw hole deposit. Particularly, at FIGS. 5A and 5B, there are centered screw holes (O) on both sides of which 0.10 grams or a 3/16″ diameter dot D2 of adhesive/putty is deposited. And, for each off centered screw hole in a plate having multiple screw holes on either side of its latch hole L, preferred deposit quantities have been found to be about 0.20 grams or ¼″ diameter dot D2 to the left, OR to the right of these off-centered screw holes, on either side of center line CL. Preferred gram weights and raised shapes will allow these volumes of adhesive/putty to be compressed, or sufficiently flattened, during installation. The aforementioned adhesive/putty volume measures are not restricted to pea-shapes or that of a sphere, hemisphere or ball. However, there is a greater risk that any shape other than spherical could reduce the effectiveness of these deposits to stick, slide or otherwise pull away for the doorjamb. For the aforementioned deposit amounts, it should be noted that a range of volume, in gram weight or in distortion from spherical, should hold a tolerance of plus or minus 25% without compromising effectiveness. Particularly, multiple dots or pea-shaped beads of as little as 0.05 grams or ⅛″ diameter may work satisfactorily though to a less preferred degree.

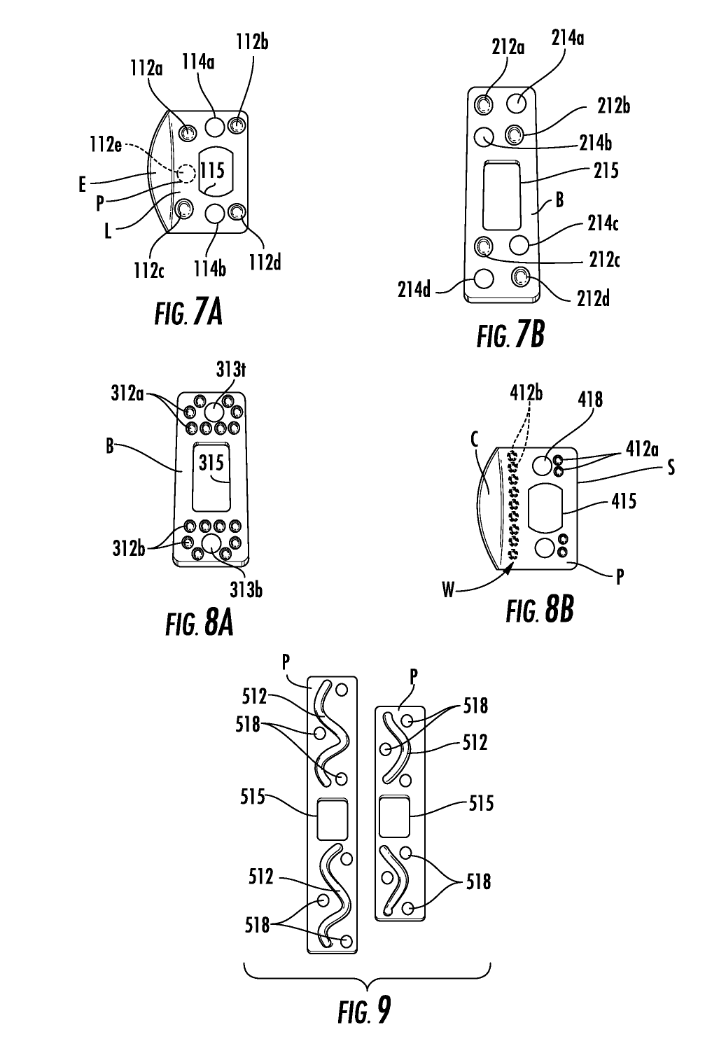

FIGS. 7A and 7B show the backsides to a door latch plate (7A) and dead bolt plate (7B) to which adhesive/putty assists have been purposefully added. Note that for FIG. 7A, there are dot/rounds additions 112a-d at the four corners to that latch plate P and an optional fifth dot 112e (shown in dashed lines) midway along the curved inner edge E to latch plate P. The latch hole 115 is positioned midway between screw holes 114a-b. By contrast, the dead bolt plate B of FIG. 7B shows a first set of diagonal dot/rounds 212a-b adjacent screw holes 212a-b above the latch hole 215 with a second pair of diagonal dot rounds 212c-d adjacent screw holes 214c-d in the lower “half” of plate B.

FIGS. 8A and B show another alternative in which much smaller adhesive “beads” are used, though in greater quantities around those plate variations. Particularly, dead bolt plate B of FIG. 8A includes eight (8) smaller beads 312a around the top screw hole 318t and an additional eight beads 312b around bottom screw hole 318b. In accompanying FIG. 8B, the door latch plate P has only one pair of adhesive beads 412a to the right (or on the short side/edge S) of the upper and lower screw holes 418 but nine (9) optional mini-balls or beads of adhesive 412b (shown via dashed lines) along the wider edge W of plate P. When these additional, optional mini-ball/beads are used, they are still carefully positioned so as to NOT extend so far outwardly as to spill over onto the curved lip C of latch plate P.

To a less preferred degree, FIG. 9 shows one non-spherical alternative to adhesive/putty application on its long 6 hole (left) and short 6 hole (right) plate P variations. Therein, snakelike curves 512 of adhesive/putty are applied so as to serpentine around the screw holes 518 and center latch hole 515 for both plate lengths. Note that this variation is adhesive/putty tends to be time constrained and more vulnerable to improper volume application. As such, it is more likely for excess adhesive/putty to bleed out when finger pressed in place onto the mortise of a door jamb.

Temperature testing of adhesive/putty depositing for both the door jamb and strike plate was also observed. Five temperatures where evaluated (110°, 70°, 32°, 28°, and 0° F.). Installing at any of these temperature, the installer was able to successfully stick, slide and hold the strike plate to the door jamb surface. However, at the lower temperatures ranges, i.e., below 32° F., additional moderate finger pressure was required to first stick and then slide the strike plate to the doorjamb. In other words, results for a successful strike plate installation was “best” at 32°, 70°, and 110° F. Only moderate finger pressure was required to stick and slide the strike plate to the door jamb. At the lower tested temperatures of 0° and 28° F., typical strike plate installations could only be summarized as “good”.

The invention proved to be “good” for exterior use and “best” for interior strike plate installations/applications. Adhesive/putty that was pre-attached to a given strike plate can be protected (until needed) with a low stick, plastic covering or any material that could serve as protection for packaging and from environmental contamination. This covering would be best removed immediately prior to installation/use.

The most common typical striker plates have two mounting holes, one on either side (or on the top and bottom) of the plate's latch (or deadbolt) hole. Larger size strike plates have more than two mounting holes. The number of mounting screw holes in the design of the strike plate should determine the proper volume required to fall within preferred volume range limits. Determined from testing trials, a pea sized dot of adhesive/putty should be used at 2× the number of mounting screw holes for a mid volume range requirement. Restated, 4 pea sized volumes should be applied for a strike plate having two mounting screw holes; 6 dollops for a plate having three mounting screw holes and eight adhesive/putty dots for a strike plate having four mounting screw holes, etc. These pea sized volume capsules should be attached to the back face of a strike plate in a relatively even distribution. Such capsule spacing will allow for firm but easy finger pressure applications when the invention is pressed to the doorjamb surface. With that nominal finger pressure exertion, these capsules become sufficiently sandwiched, flattened or squeezed without the front face of the strike plate interfering with, binding or rubbing against the inside edge of the door surface. If less than a uniform distribution or clumping-together of capsules is applied, the amount of finger pressure compression is reduced resulting in a less-than-even distribution of adhesive/putty that could: (a) interfere with the gap-opening clearance between strike plate and the door's inside edge; and/or (b) distort/bend or bow the strike plate itself.

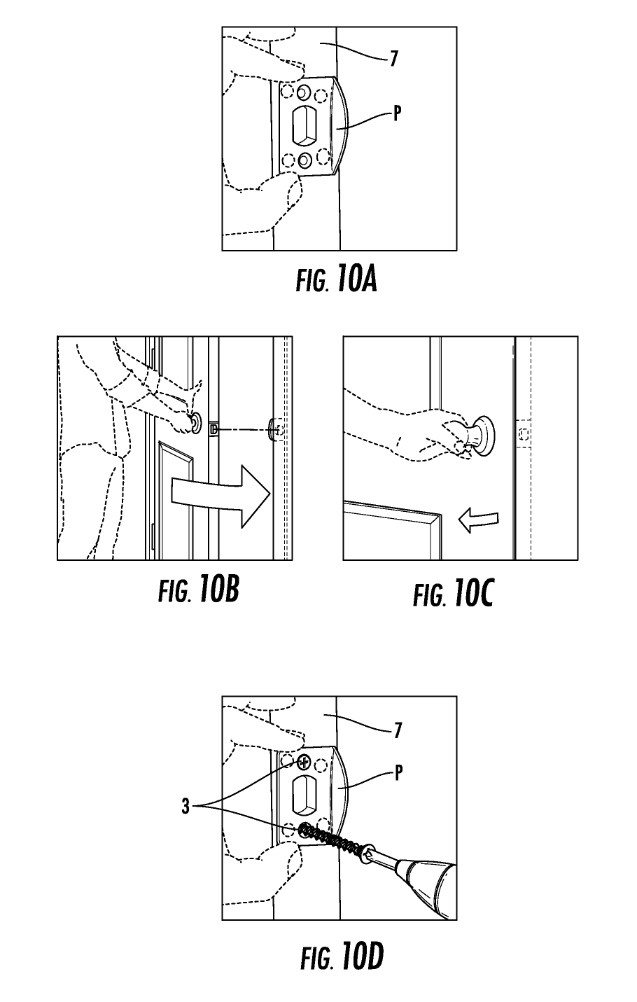

For installation of a strike plate per this invention, the latch or dead bolt assembly must first be installed into the side edge of a door and its doorjamb mating/mirror image roughed-in, or counter sunk by the cutting of a recess hole-cavity mortise that will allow the latch or dead bolt to move freely/easily in and out-back and forth. Then, the remaining steps for strike plate installation commence, these method steps being depicted sequentially in accompanying FIGS. 10A through 10D. Particularly:

Step 1 (10A)—First stick the puttied strike plate P onto the door jam's inside surface 7 to mate with the lock set latch or deadbolt and approximate its proper location by eyeballing, ball-parking or using a rough guess approach. This can be accomplished by pressing the puttied strike plate's front surface inward with firm finger pressure allowing the plate to stick somewhat into the doorjamb surround.

Step 2—Test the plate placement by closing the door with the puttied plate IN PLACE (FIG. 10B) and then pulling on the closed door (FIG. 10C) for checking on satisfactory plate location or alignment. If the door does not fully shut and/or rocks back and forth ever so slightly, if the door catches on the strike plate proper, or if the dead bolt does not easily slide into the striker, there has not been a first proper fit of the strike plate to the door frame.

So, first open the door to slide the puttied strike plate for adjustment. Adjust the plate by moving it with one's fingers in a push/pull fashion, up/down, left/right or in/out direction until the striker is engaged and duly latches with door edge interference. Repeat the previous door opening and closing action to verify to the installer's satisfaction that a perfect, or near perfect strike plate location has been determined. That includes testing/checking to make sure no rattling happens when the door is completely closed/secured. With the present invention, multiple locations/relocations may be made and retested until the strike plate is in a satisfactory spot.

Step 3 (10D)—After the perfect strike plate fit has been verified, open the door once more and secure the plate to its correct position by installing the plurality of permanent mounting screws 3 therein.

With this invention, total installation time is reduced significantly and made easier, let alone less frustrating to the installer. Normal experience from installer alignment trails note ease with adjusting and time spent for both the amateur and skilled carpenter installer. A perfect fit can be achieved with fewer, preferably two (and maybe three or four, at most) “volleys” in testing, sliding and then repeating the test, in two minutes total. Some installers were able to obtain the perfect fit in just 30 seconds.

Using a special properties adhesive/putty not for fastening but for preliminary positioning makes installing a door strike plate with little or no adjustment to one that allows for easy and complete location adjustability before the plate's permanent mounting screws are fastened. The invention makes the strike plate installing experience one that is easy to accomplish, decreasing the frustration and time for both the amateur or professional using the aforesaid method steps of: stick/test/slide/and retest. The invention's multi-directional adjustability feature results in a door that will always open and close easily/smoothly. And when that door is shut, it will NOT move around or rattle thereby increasing the door assembly's security, sound dampening and/or energy efficiency.

With respect to the adhesive/putty formulation, it is important to have a composition that holds the strike plate to the doorframe for a sufficient amount of time, but it need not be indefinite. In fact, when a stronger adhesive variety is used, it tends to grip too strongly and NOT enable further, subsequent relocation of the striker in the event the first placement is erroneous, however slight. For this reason, it is preferred that one or more of the following compounds be used as the adhesive/putty of choice herein: DAP BlueStik, as made and sold by DAP Products Inc.; Duck Poster Putty as made and sold by Duck brand; Bostik brand putty. Fast Tak as made and sold by 3M, Tack-N-Stick as made and sold by Elmer's Products, Inc., Fun Tak as made and sold by Locktite, HandiTak, UHU Tac, and Velcro brand Sticky Fix Tac. These are but several examples of known materials; it being understood that still other new or existing adhesive/putties may be blended therewith and/or substituted therefor.

Having described the presently preferred embodiments, it is to be understood that the invention may be otherwise embodied within the scope of the appended claims.

1. A door strike plate that can be temporarily mounted to a first location for proper alignment, tested while still temporarily mounted and moved multi-directionally to a second location if the first location is not properly aligned, said door strike plate comprising: a metal strike plate having at least one mounting screw hole on a top side and a bottom side of a centrally-located latch or deadbolt hole; an appropriately sized volume of a non-curing adhesive or putty applied to a region adjacent each mounting screw hole in the metal strike plate for allowing the metal strike plate to be: (i) temporarily mounted to the first location on a door frame, (ii) tested for proper alignment while still temporarily mounted; (iii) moved multi-directionally to the second location if not properly aligned; and (iv) retested until location of the metal strike plate is satisfactory; and a permanent mounting screw for each mounting screw hole in the metal strike plate.

2. The door strike plate of claim 1 wherein the metal strike plate has one mounting screw hole on each side of the latch or deadbolt hole and at least one dot of the non-curing adhesive or putty is applied adjacent both sides of each mounting screw hole.

3. The door strike plate of claim 2 wherein the metal strike plate has a plurality of dots of the non-curing adhesive or putty applied around each mounting screw hole.

4. The door strike plate of claim 1 wherein each volume of the non-curing adhesive or putty weighs at least about 0.05 gram.

5. The door strike plate of claim 1 wherein each volume of the non-curing adhesive or putty measures at least about ⅛″ in diameter.

6. The door strike plate of claim 1 wherein each volume of the non-curing adhesive or putty weighs about 0.20 grams or less.

7. The door strike plate of claim 1 wherein each volume of the non-curing adhesive or putty measures about ¼″ in diameter or less.

8. The door strike plate of claim 1 wherein the metal strike plate includes more than two mounting screw holes and a dot of the non-curing adhesive or putty adjacent each mounting screw hole.

9. The door strike plate of claim 8 wherein the metal strike plate includes four to six mounting screw holes and four to six dots of the non-curing adhesive or putty.

10. The door strike plate of claim 1 wherein each dot of the non-curing adhesive or putty is applied in advance and covered with a protective sheet that gets removed prior to the first temporary mounting.

11. The door strike plate of claim 1 wherein the non-curing adhesive or putty is applied to the metal strike plate prior to temporary mounting to the first location on the door frame.

12. The door strike plate of claim 1 wherein the adhesive/putty is selected from the group consisting of: DAP BlueStik, Duck Poster Putty, Elmer's Tack-N-Stick, Bostik brand putty, 3M Fast Tak, Locktite Fun Tak, HandiTak, UHU Tac. and Velcro brand Sticky Fix Tac.

13. The door strike plate of claim 1 which further includes a security reinforcer, said security reinforcer having one or more dots of the non-curing adhesive or putty applied to an underside thereof.

14. A door strike plate that can be temporarily mounted without temporary screws to a first location for proper alignment, tested while still temporarily mounted and moved multi-directionally to a second or more locations until satisfactorily aligned, said door strike plate comprising: a metal strike plate having a plurality of mounting screw holes on a top and bottom side of a latch or deadbolt hole; an appropriately sized dot of a putty applied to a region adjacent each mounting screw hole in the metal strike plate for allowing the metal strike plate to be: (i) temporarily mounted to the first location on a door frame, (ii) tested for proper alignment while still temporarily mounted; (iii) moved multi-directionally to the second location if not properly aligned; and (iv) retested; and a permanent mounting screw for each mounting screw hole in the metal strike plate.

15. The door strike plate of claim 14 wherein each dot of the putty weighs between about 0.05-0.20 grams.

16. The door strike plate of claim 14 wherein each dot of the putty measures about ⅛″ to ¼″ in diameter.

17. The door strike plate of claim 14 wherein each dot of the putty is applied in advance and covered with a protective sheet that gets removed prior to the first temporary mounting.

18. An improved method for installing a door strike plate to properly align to a mortise in a door jamb, said method comprising the steps of: (a) providing a door strike plate that includes: a metal strike plate having a plurality of mounting screw holes on a top side and a bottom side of a latch or deadbolt hole; and an appropriately sized dot of a temporarily-adhering putty applied to a region adjacent each mounting screw hole in the metal strike plate; (b) positioning the door strike plate at a first location on the doorjamb and applying finger pressure to the putty for temporarily securing the door strike plate to the first location without temporary mounting screws; (c) testing whether the first location is properly aligned so that a door closes tightly without rattling; and (d) if properly aligned, securing the door strike plate to the first location with permanent mounting screws, but if not properly aligned: (i) adjusting the door strike plate multi-directionally to a second location; (ii) testing whether the second location is properly aligned so that the door closes tightly without rattling; (iii) if still not satisfactorily aligned, moving the door strike plate to another location and retesting for proper alignment; and (e) when satisfactorily aligned, securing the door strike plate to a final location with permanent mounting screws.

19. The method of claim 18 wherein substep (d)(i) includes moving the door strike plate up or down and in or out with finger pressure.

20. The method of claim 18 wherein the putty dots are applied to the door strike plate in advance and covered with a protective sheet, and the method comprises the further step of: removing the protective sheet covering the temporarily adhering putty dots prior to the first door strike positioning step (b).
